(19) United States
(12) Patent Application Publication
(10) Pub. No.: US 2009/0254980 A1
(43) Pub. Date: Oct. 8, 2009

(54) METHOD OF PROVIDING ACCESS RIGHTS BASED ON DEVICE PROXIMITY AND CENTRAL ACCESS DEVICE USED FOR THE METHOD

(75) Inventor: Shrikant Kanaparti, Karnataka (IN)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/301,738

(22) PCT Filed: Jul. 10, 2007
(86) PCT No.: PCT/KR07/03329

§ 371 Date: Nov. 20, 2008

(30) Foreign Application Priority Data
Jul. 10, 2006 (IN) 1210/CHE/2006
Feb. 13, 2007 (KR) 10-2007-0015098

(51) Int. Cl. G06F 17/30; H04B 7/00

(52) U.S. Cl. 726/4; 455/41.2

(57) ABSTRACT

Provided is method of providing access rights based on device proximity and central access device used for method. Method of providing access rights to mobile device includes: determining proximity showing how close mobile device is to central access device when mobile device connects to central access device in home network; and granting access right to mobile device according to determined proximity. Access rights used for protecting contents of various devices in home network can be seamlessly controlled, and in network, identity of person (identified by his/her device) can be generated and his/her access right can be properly controlled. In addition, there is no need to concern about leakage of data beyond the house and there is no need to try to change anything of set parameters for this purpose, and there is no need to try to protect data in a ubiquitous information network.

### CROSS-REFERENCE TO RELATED PATENT APPLICATION

This application is a National Stage of International Application No. PCT/KR2007/003329 filed Jul. 10, 2007, and claims the benefit of Korean Patent Application No. 10-2007-0015098, filed on Feb. 13, 2007, in the Korean Intellectual Property Office, and the benefit of Indian Patent Application No. 1210/CHE/2006, filed on Jul. 10, 2006, in the Indian Patent Office, the disclosures of which are incorporated herein in their entirety by reference.

### BACKGROUND OF THE INVENTION

1. Field of the Invention

Methods and devices consistent with the present invention relate to a network field, and more particularly, to managing access rights for devices in a home network and protecting data shared between the devices.

2. Description of the Related Art

Now, there are several defined remote control mechanisms. The mechanisms are not limited to a home network, and most of the mechanisms are defined for a company network using a technology such as a virtual private network (VPN). However, technologies used for the mechanisms are not fully described as in the current description. In addition, the technologies are not automated and therefore need involvement with a user for every authentication whenever the user wants to connect to devices in a network.

### SUMMARY OF THE INVENTION

An aspect of an exemplary embodiment of the present invention provides a method of providing access rights as an automated remote control mechanism for a mobile device connecting to a home network.

An aspect of an exemplary embodiment of the present invention also provides a central access device used for the method of providing access rights.

An aspect of an exemplary embodiment of the present invention also provides a computer-readable medium having embodied thereon a computer program for executing the method of providing access rights.

According to an aspect of the present invention, there is provided a method of providing access rights based on proximity of a mobile device by a central access device in a home network to the mobile device in order to connect the mobile device to the home network, the method comprising: determining proximity showing how close the mobile device is to the central access device when the mobile device connects to the central access device; and granting an access right to the mobile device according to the determined proximity.

According to another aspect of the present invention, there is provided a central access device providing access rights based on proximity of a mobile device in order to connect the mobile device to a home network, the central access device comprising: a proximity determination unit which determines the proximity showing how close the mobile device is to the central access device when the mobile device connects to the central access device; and an access right grant unit which grants an access right according to the proximity determined for the mobile device.

The proximity determination unit may determine the proximity of the mobile device based on a type of a network on which the mobile device connects to the central access device. The proximity determination unit may determine that the mobile device connects inside the home network when the mobile device connects by using a short-distance wireless communication link, and determine that the mobile device connects outside the home network when the mobile device connects by using a long-distance communication link. The access right grant unit may determine to encrypt data provided to the mobile device when it is determined that the mobile device connects outside the home network.

The proximity determination unit may determine a position of the mobile device based on strength of signals transmitted from the mobile device. The access right grant unit may determine to encrypt data provided to the mobile device when it is determined that the position of the mobile device determined based on the strength of the signals is further than a reference distance.

The central access device may be a residential gateway.

### BRIEF DESCRIPTION OF THE DRAWINGS

The above and other features and aspects of the present invention will become more apparent by describing in detail exemplary embodiments thereof with reference to the attached drawings in which:

FIG. 1 is a view showing an example of devices connecting to a home network;

FIG. 2 is a view showing an example of a residential gateway;

FIG. 3 is a view showing a method of providing access rights according to an exemplary embodiment of the present invention; and

FIG. 4 is a view showing a central access device according to an exemplary embodiment of the present invention.

### DETAILED DESCRIPTION OF THE INVENTION

Hereinafter, a method of providing access rights based on device proximity and a central access device used for the method according to exemplary embodiments of the present invention will be described in detail with reference to the attached drawings.

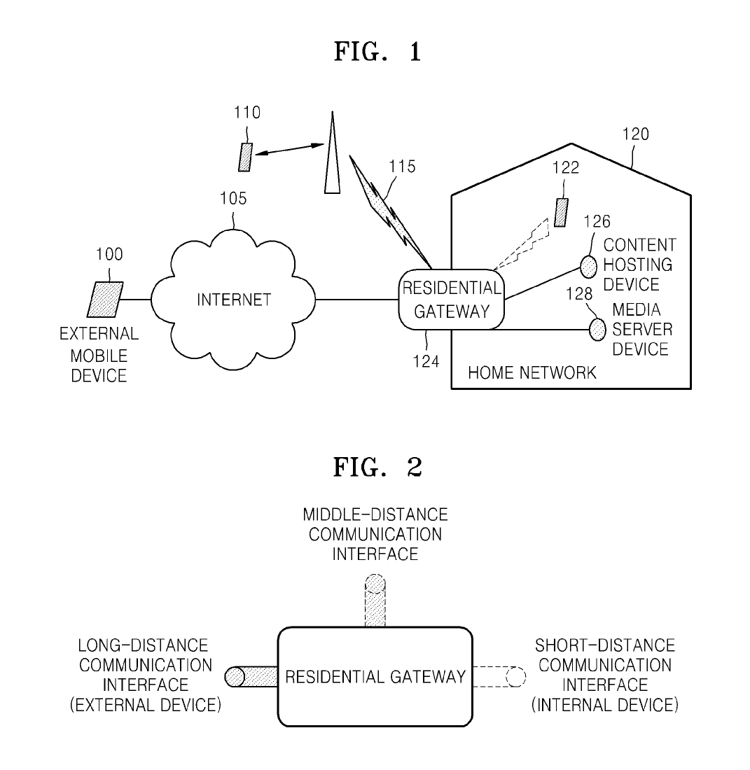

FIG. 1 is a view showing an example of devices connecting to a home network.

Hereinafter the following acronyms are used as follows:

GPS: Global Positioning System

HTTP: HyperText Transfer Protocol

HTTPS: HTTP over SSL

ISP: Internet Service Provider

IP: Internet Protocol

RG: Residential Gateway

SSL: Secure Sockets Layer

UpnP: Universal Plug & Play

VPN: Virtual Private Network

WAN: Wide Area Network

Referring to FIG. 1, the devices connecting to the home network 120 include external mobile devices 100 and 110 and an internal mobile device 122.

The external mobile devices 100 and 110 may connect to the home network 120 through the Internet 105 or using a wireless connection 115.

The home network 120 has a device for performing access control so as to allow the mobile device to connect to the home network 120. The device is called a central access device. In FIG. 1, as an example of the central access device, a residential gateway (RG) 124 is shown.

In the home network 120, a content hosting device 126, a media server device 128, and the like are connected in order to provide services to the devices connecting to the home network 120. The content hosting device 126, the media server device 128, and the like are also connected to the central access device (the residential gateway 124 in FIG. 1).

In a home networking environment, the central access device (the central access device is generally the residential gateway) has to have intelligence necessary to decide whether or not to give a needed access right based on a position of a user while the user is connecting to the home network 120. This is generally applied only to the mobile device.

A rationale for this is to prevent pilferage into the home network by a user who is not known when the mobile device is far from the home. This is because a remote device cannot confirm whether or not the user is a right user by using only the device connecting to the home network 120. Examples of a short-distance wireless communication link may include WiFi and Bluetooth. On the contrary, examples of a long-distance wireless communication link may include worldwide interoperability for microwave access (WiMax) and 3G. External connection is performed on a VPN or a HTTPS link due to security reasons. In order to activate the home network itself and provide seamless transactions for checking devices and services provided from the devices, standards such as UPNP exist.

The RG 124 is the only device for providing heterogeneous connectivity in order to satisfy needs of various devices in the home network 120. The mobile devices can support one or more connection types for supporting different connection requests. The mobile devices use available network types based on proximity for device networks. Proximity information is based on a type of a network connecting a user device to the central access device. This can be improved based on the position within connection with the same type (for example, based on simple parameters such as strength of a signal) in order to find the proximity information without using a technology such as GPS.

According to the exemplary embodiment of the present invention, a plurality of intelligence can be implemented. For example, there is an access right policy used with encryption. In addition, there is encryption of plural levels employed with a simple access policy.

The RG as a device having a plurality of communication interfaces may provide application logic needed for a needed result. In this case, finding the proximity information from a connected interface and analysis are required.

The home network is a network of internal and neighboring devices for providing communication links therebetween. The communication links may be used for various purposes such as data transmission, device control, or other purposes generally required in a home. In the market, various standards formed for the purposes exist.

FIG. 2 is a view showing an example of the RG. The RG is a device for providing heterogeneous connectivity for satisfying requirements of various devices in the home network. The RG is a central device which is unchangeable to activate operations over the entire home network and serves as a hub of the system. Roles of the RG are to provide connectivity having a plurality of types for seamless connection between the devices in the network and perform data conversion/code conversion for meaningful interactions between the devices when required. In addition, the RG serves as a device interfacing with the home network and an external system (that is, external systems connected to the RG through the Internet). Accordingly, the RG includes communication interfaces, media codes, and conversion devices having various types.

According to the exemplary embodiment of the present invention, a seamless mechanism for controlling access rights between the home network and the devices using the characteristics of the RG is provided.

The types of the communication interfaces provided by the RG are based on types of connection needed for the devices neighboring to the home. In addition, the communication links have ranges so that the communication links can practically provide services. More specifically, the communication links are limited by their proximity between two devices that can communicate. For example, there is a short-distance communication link mainly provided inside the home network. In addition, there is a long-distance communication service which is conventionally provided by an external provider and has a charge for services.

In the home network, access permission always can be defined and is determined using various standards. A conventional method widely performed in the market is performed by identifying a user using login details based on identification of a needed access right set for the user.

According to the exemplary embodiment of the present invention, the permission standards are defined according to a type of connection for deciding his/her access right. The access rights may be a set of permissions defined in advance ideally by a person who has rights to decide the access rights (for example, an owner of the house).

Therefore, an assumption that the devices have wireless ability is needed. When the mobile device has a different access right for the same device based on a connecting position, the devices have connectivity with a plurality of types for the mobile devices. Another assumption is that when the user has close proximity in the home network, the user uses a short-distance link, and when the user has far proximity, the user uses a long-distance link. When the devices have one or more communication interfaces, the mobile device operates according to the same thumb rule. This is because it is economically helpful to these options. The house owner sets needed permission conditions for the devices and this provides a needed access to the house.

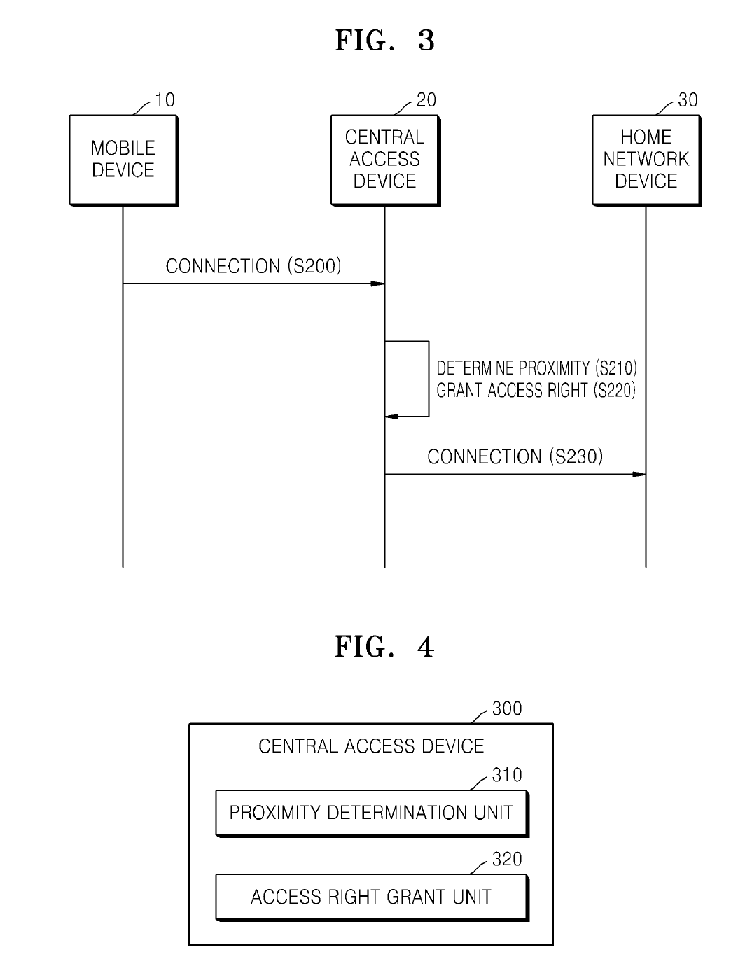

FIG. 3 is a view showing a method of providing access rights according to an exemplary embodiment of the present invention.

First, the mobile device 10 is connected to the home network by connecting to the central access device 20 (operation S200). Here, it is assumed that the mobile device 10 is connected to the home network by an optimal method for the mobile device 10. For example, when a device in the home network is possible to connect to the central access device 20 through the short-distance wireless communication link, the device does not connect to the central access device 20 through the long-distance communication link.

The central access device 20 determines proximity of the mobile device 10 (operation S210) and grants an access right to the mobile device 10 according to the determined proximity (operation S220).

The central access device 20 connects to a home network device 30 requested to connect by the mobile device 10 in a proper method according to the access right (operation S230).

FIG. 4 is a view showing a central access device according to an exemplary embodiment of the present invention. Referring to FIG. 4, the central access device 300 includes a proximity determination unit 310 and an access right grant unit 320.

When the mobile device 10 connects to the central access device 20, the proximity determination unit 310 determines proximity showing how close is the mobile device 10 to the central access device 20.

The access right grant unit 320 may grant a different access right to the mobile device 10 according to the determined proximity.

An exemplary embodiment according to the present invention is as follows.
Little son Jerry of Tom has his personal e-book reader and connects to a complete collection of digital books which are his family's favorites through the e-book reader at home, and the connection to their central media server is always available.
However, Jerry always brings the e-book reader wherever he goes, and his friends want to read a book by using his e-book reader through connecting to the media server (and they want to share their books).
For this reason, Tom sets a remote access permission to his e-book reader to allow Jerry to connect to data based on his proximity.
When he is at home or near the home, he can perfectly connect to the family's collection, and when he goes out, he has a limited connection to a few selected digital books.
All operations are controlled by a residential gateway and its remote access control intelligence.

This is a simple exemplary embodiment as an application model. In addition, other scenarios using these characteristics can be used.

According to another exemplary embodiment, a short-distance interaction uses non-encrypted data access, and a long-distance data access is encrypted to the same person and forms an additional layer for protecting data for the device in the home network.

In addition, another exemplary embodiment is described as follows.

The access rights for the devices in the home network were described. However, this can be easily extended to other fields.

There are several examples.

1. When a mobile device becomes distant more than predetermined proximity, data is encrypted.

2. When the mobile device becomes distant more than predetermined proximity, a control device is operated. For example, when a person goes out of his house while keeping his wireless device, as proximity of the wireless device becomes distant, an air conditioner may be controlled to be turned off.

The aforementioned operations require different logics of the residential gateway in order to arrive at a needed decision based on the proximity information transmitted from each of the devices. For example, the access rights are accomplished by examining the set access right policy, and encryption is generated by using an encryption engine.

Aspects of the present invention are as follows.

1. The access rights can be seamlessly controlled to protect contents of various devices in the home network.

2. In the network, intelligence of a person (identified by his/her device) can be generated and his/her access right can be properly controlled.

3. There is no need to concern about leakage of data beyond the proximity of a home and there is no need to try to change anything of set parameters for this purpose.

4. There is no need to try to protect data in a ubiquitous information network which has been widely introduced.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. In other exemplary embodiments, the computer readable recording medium may include carrier waves (such as data transmission through the Internet).

While the present invention has been particularly shown and described with reference to exemplary embodiments thereof, it will be understood by those skilled in the art that various changes in form and details may be made therein without departing from the spirit and scope of the present invention as defined by the appended claims.

1. A method of providing access rights based on a proximity of a mobile device by a central access device in a home network to the mobile device to connect the mobile device to the home network, the method comprising:
determining the proximity of the mobile device indicating a closeness of the mobile device to the central access device when the mobile device connects to the central access device; and
granting an access right to the mobile device according to the determined proximity.

2. The method of claim 1, wherein the determining the proximity of the mobile device comprises determining the proximity of the mobile device based on a type of a network through which the mobile device connects to the central access device.

3. The method of claim 2, wherein the determining the proximity of the mobile device based on the type of the network through which the mobile device connects to the central access device comprises:
if the mobile device connects by using a short-distance wireless communication link, determining that the mobile device connects from within the home network; and
if the mobile device connects by using a long-distance communication link, determining that the mobile device connects from outside the home network.

4. The method of claim 3, wherein the granting the access right to the mobile device comprises determining to encrypt data provided to the mobile device if it is determined that the mobile device connects from outside the home network.

5. The method of claim 1, wherein the determining proximity of the mobile device comprises determining a position of the mobile device based on strengths of signals transmitted from the mobile device.

6. The method of claim 5, wherein the granting the access right to the mobile device comprises determining to encrypt data provided to the mobile device if it is determined that the position of the mobile device determined based on the strengths of the signals is further away than a reference distance.

7. The method of claim 1, wherein the central access device is a residential gateway.

8. A central access device which provides access rights based on proximity of a mobile device to connect the mobile device to a home network, the central access device comprising:
a proximity determination unit which determines the proximity of the mobile device indicating a closeness of the mobile device to the central access device when the mobile device connects to the central access device; and
an access right grant unit which grants an access right according to the determined proximity of the mobile device.

9. The central access device of claim 8, wherein the proximity determination unit determines the proximity of the mobile device based on a type of a network through which the mobile device connects to the central access device.

10. The central access device of claim 9, wherein the proximity determination unit determines that the mobile device connects from within the home network if the mobile device connects by using a short-distance wireless communication link, and determines that the mobile device connects from outside the home network if the mobile device connects by using a long-distance communication link.

11. The central access device of claim 10, wherein the access right grant unit determines to encrypt data provided to the mobile device if it is determined that the mobile device connects from outside the home network.

12. The central access device of claim 8, wherein the proximity determination unit determines a position of the mobile device based on strengths of signals transmitted from the mobile device.

13. The central access device of claim 12, wherein the access right grant unit determines to encrypt data provided to the mobile device if it is determined that the position of the mobile device determined based on the strengths of the signals is further away than a reference distance.

14. The central access device of claim 8, wherein the central access device is a residential gateway.

15. A computer-readable medium having embodied thereon a computer program for a method of providing access rights based on a proximity of a mobile device by a central access device in a home network to a mobile device to connect the mobile device to the home network, wherein the method comprises:
determining the proximity of the mobile device indicating a closeness of the mobile device is to the central access device when the mobile device connects to the central access device; and
granting an access right to the mobile device according to the determined proximity.
